(19) United States
(12) Patent Application Publication
(10) Pub. No.: US 2010/0261019 A1
(43) Pub. Date: Oct. 14, 2010

(54) Primer Composition and Metal-Rubber Laminate Using the Same

(76) Inventors: Shinichiro Sano, Kanagawa (JP); Katsumi Abe, Kanagawa (JP); Kiyofumi Fukasawa, Kanagawa (JP)

Correspondence Address: Brinks Hofer Gilson & Lione/Ann Arbor, 524 South Main Street, Suite 200, Ann Arbor, MI, 48104, US

(21) Appl. No.: 12/083,525

(22) PCT Filed: Oct. 2, 2006
(86) PCT No.: PCT/JP2006/319680

§ 371 Date: Apr. 14, 2008

(30) Foreign Application Priority Data
Oct. 13, 2005 (JP) 2005-298395
Oct. 13, 2005 (JP) 2005-298396

(51) Int. Cl. B32B 15/08; C08L 27/12; B32B 27/32; C08L 29/08

(52) U.S. Cl. 428/421; 524/543; 428/461

(57) ABSTRACT

A primer composition for use as a primer in the production of metal/primer/adhesive/rubber laminates, which comprises 100 parts by weight of polyparavinylphenol and 50-300 parts by weight of an organometallic compound can give distinguished water resistance and acid resistance, when used for vulcanization bonding of a plated steel sheet and unvulcanized rubber or for simple bonding of a plated steel sheet and vulcanized rubber, and metal-rubber laminates produced by using the primer composition can be effectively used as rubber-metal integrated type gaskets, particularly fuel cell gaskets, HDD cover gaskets (metallic separator-integrated type gaskets), etc.

### TECHNICAL FIELD

The present invention relates to a primer composition and a metal-rubber laminate using the same, and more particularly to a primer composition for use as a primer in the production of a metal/primer/adhesive/rubber laminate, and a metal-rubber laminate using the same.

### BACKGROUND ART

Fuel cell gaskets require a water resistance and an acid resistance, so their plate surfaces are plated with gold, etc. Vulcanization bonding of such plated steel sheets and unvulcanized rubber fails to give a stable initial adhesiveness, even if the rubber bonding is carried out with the conventional vulcanization adhesive.

Initial adhesiveness of a chemically less active plated steel sheets can be considerably improved by coating the steel sheets with a primer containing a silane coupling agent as the main component, as a pretreatment for applying a vulcanization adhesive thereto, but there is still such a problem as poor water resistance. Gaskets for electronic memory devices, particularly hard disc drives (HDD), require low out-gassing characteristics and not containing Si, S, Cl, etc. therein, and thus it is not preferable to use such a primer containing a silane coupling agent as the main component.

The water resistance can be improved with a vulcanization bonding primer containing a copolymerization oligomer of an amino group-containing alkoxysilane with a vinyl group-containing alkoxysilane and an organometallic compound, but there is a still further improvement in the acid resistance durability as a problem.

Patent Literature 1: JP-A-2004-26848

In the case of simple bonding of plated steel sheets and vulcanized rubber, a thermosetting resin such as phenol resin and epoxy resin can be used as adhesives capable of satisfying the requirements for water resistance and acid resistance, but even these adhesives have a poor adhesiveness to chemically less active plated steel sheets, and in the acid resistance durability tests peeling takes place between the steel sheet and the adhesive layer.

In connection to these adhesive systems, the present applicants had previously proposed coating with a primer containing either a resol-type phenol resin or a novolak-type phenol resin, or both together, and also an organometallic compound as the main components to improve the acid resistance and the water resistance, but it was found that, for example, dipping in a 0.5% sulfuric acid solution heated to 80° C. for 500 hours caused peeling between the primer and the over coated adhesive, therefore there is desired a still further improvement.

Patent Literature 2: JP-A-2006-206616

### DISCLOSURE OF THE INVENTION

### Problem to be Solved by the Invention

An object of the present invention is to provide a primer composition capable of giving distinguished water resistance and acid resistance in vulcanization bonding of a plated steel sheet and unvulcanized rubber, or even in simple bonding of a plated steel sheet and a vulcanized rubber, and also a metal-rubber laminate using the same.

### Means for Solving the Problem

The object of the present invention can be attained by a primer composition, for use as a primer in the production of a metal/primer/adhesive/rubber laminate, which comprises 100 parts by weight of polyparavinylphenol and 50-300 parts by weight of an organometallic compound. Thus, the present invention can provide a metal-rubber laminate, that is, a metal/primer/adhesive/rubber laminate produced by using the present primer composition.

### EFFECT OF THE INVENTION

The present primer composition, when used as a primer in the production of a metal/primer/adhesive/rubber laminate, can give a metal-rubber laminate having distinguished water resistance and acid resistance in the case of either vulcanization bonding of less active plated steel sheet and unvulcanized rubber or simple bonding of the plated steel sheet and vulcanized rubber, where liquid fluororubber can be preferably used as unvulcanized rubber for forming a rubber layer.

### BEST MODES FOR CARRYING OUT THE INVENTION

Polyparavinylphenol for use as one component for the primer composition, includes commercially available products, for example, Maruka Linker M, a product of Maruzen Petrochemical Co., which can be used directly as such.

An organometallic compound for use as adding component to these polyparavinylphenol includes, for example, organoaluminum compounds such as triisopropoxy aluminum, mono-sec-butoxydipropoxy aluminum, tri-sec-butoxy aluminum, ethylacetoacetate aluminum diisopropylate, aluminum tris(ethylacetoacetate), aluminum monoacetylacetonate bisethylacetoacetate, aluminum tris(acetylacetate), etc.; organotitanium compounds such as titanium lactate, tetraisopropoxytitanium, tetra-n-butoxytitanium, diisopropoxytitanium bis(ethylacetoacetate), 1,3-propanedioxytitanium bis(ethylacetoacetate), diisopropoxytitanium bis(acetylacetonate), titanium tetracetylacetonate, etc.; organozirconium compounds such as tetra-n-propylzirconium, tetra-n-butoxyzirconium, di-n-butoxyzirconium-bis(acetylacetonate), di-n-butoxyzirconium-bis(ethylacetoacetate), etc.; and organotin compounds such as dibutyl tin dilaurate, dibutyl tin dioctate, dioctyl tin dilaurate, etc. The organometallic compounds mostly have a limited solvent availability, and thus organoaluminum compounds composed of one or more chelate rings or alkoxy groups, represented by the following formula:

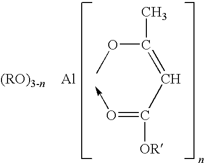

, where R and R′ each are a lower alkyl group such as CH₃, C₂H₅, n-C₃H₇, i-C₃H₇, n-C₄H₉, i-C₄H₉, etc., and n is an integer of 0-3, or a titanium acetylacetonate, represented by the following formula:

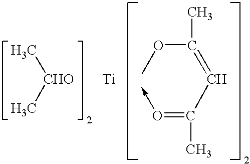

, or a titanium lactate, represented by the following formula:

Ti(OH)₂[OCH(CH₃)COOH]₂

, all of which have a relatively high degree of freedom in the solvent selection, can be preferably used.

The organometallic compound can be used in a proportion of about 50 to about 300 parts by weight, preferably about 100 to about 200 parts by weight, on the basis of 100 parts by weight of polyparavinylphenol. When the organometallic compound is used in a proportion of less than about 50 parts by weight, particularly the adhesiveness to the plated steel sheet will be lowered, whereas in a proportion above about 300 parts by weight, the acid resistance durability will be lowered.

The primer composition comprising the afore-mentioned components as essential components can be used in the form of a solution upon dilution with an organic solvent so that a concentration in total of the afore-mentioned components can be set to about 1 to about 10 wt. %. The organic solvent is not particularly limited, so far as the polyparavinylphenol and the organometallic compound can be stably dissolved therein, and generally includes alcohols such as metanol, ethanol, isopropanol, etc.; ketones such as methyl ethyl ketone, methyl isobutyl ketone, etc.; esters such as ethyl acetate, propyl acetate, etc.; and ethers such as 2-ethoxyethanol, 2-butoxyethanol, etc.

The primer solution can be applied to a metal, generally a steel sheet such as a stainless steel sheet, an aluminum steel sheet, etc., particularly a plated steel sheet in the present invention, with a film thickness of about 0.5 to about 30 μm by any coating method such as spraying, dipping, brush coating, roll coater application, etc., followed by drying at room temperature or in a hot air, and by baking treatment at about 100° to about 250° C. for about 0.5 to about 3 hours. The stainless steel sheet for use herein includes stainless steel sheets of such grades as SUS301, SUS301H, SUS304, SUS430, etc. To enhance the corrosion resistance, it is preferable to use stainless steel sheets, aluminum steel sheets, etc. whose surfaces are plated with gold, nickel, etc.

A vulcanization adhesive selected depending on the species of rubber to be vulcanization bonded can be applied to the surface of the thus formed primer layer. When a liquid fluororubber, as will be given below, is used, a specifically designed adhesives for the liquid fluororubber, for example, SF-12, SF-12-R, etc., products of Shin-Etsu Chemical Co., Ltd., are used in the form of a solution in a fluorinated solvent such as m-bis(trifluoromethyl)benzene [hexafluoro-m-xylene], etc. The vulcanization adhesive can be applied to the surface of the primer-treated steel sheet by any coating method such as spraying, dipping, brush coating, roll coater application, etc., followed by drying and by baking treatment under appropriate drying conditions and baking conditions, respectively.

The primer can be used not only in the vulcanization bonding of a steel sheet and unvulcanized rubber, but also to simple bonding of a steel sheet and vulcanized rubber. Any adhesive can be used for the bonding to the vulcanized rubber, but when the water resistance and the acid resistance are required for the resulting laminates, it is preferable to use a thermosetting resin such as epoxy resin or phenol resin.

A rubber layer is then formed on the surface of the thus formed adhesive layer, using an unvulcanized rubber compound comprising fluororubber, NBR, hydrogenated NBR, acrylic rubber, EPDM, chloroprene rubber, or the like, together with a vulcanizing agent, a reinforcing agent, and other necessary compounding ingredients, preferably an unvulcanized fluororubber compound or EPDM compound from the viewpoint of the water resistance and the acid resistance. A compound of liquid fluororubber, which is a linear fluoropolymer compound having the main chain represented by the following general formula in the molecule:

[CF₂CF(CF₃)O]ₙ

and having hydrolyzable silyl groups at both terminals of the molecular chain, and having a room temperature viscosity of not more than 10⁵ poises, preferably not more than 10⁴ poises (B-type viscometer) can be also used for the unvulcanized fluororubber compound. The liquid fluororubber makes up a room temperature-curable type, liquid fluororubber compound together with an organosilicon compound having at least two silanol groups in the molecule and a condensation promoter. Such a liquid rubber includes commercially available products, for example, SIFEL series of products of Shin-Etsu Chemical Co., Ltd. (two-liquid type 3400A/B, 3511A/B, 3702A/B, etc. capable of giving vulcanized fluororubbers having different hardnesses, depending on use and required characteristics), which can be used directly as such.

Patent Literature 3: JP-A-9-77944

Patent Literature 4: U.S. Pat. No. 5,837,774

For fuel cell gaskets, it is necessary to use rubber materials having a relatively low hardness, depending on the strength of separators, etc. to be used together. Generally, the fluororubber has a high hardness, so it is preferable to use a liquid fluororubber having a low hardness. Due to the recent requirements for stack size reduction, the fuel cell gaskets are designed in a shape of very small thickness and so LIM molding is very effective for liquid rubber in the case of molding of such a small thickness (whereas SIM molding is not advantageous in respect to the molding pressure and flowability). Generally, the liquid rubber has a short time for mold-curing as an advantage. In view of these advantages, liquid fluororubber is used as a suitable molding material particularly for fuel cell gaskets.

A rubber layer can be formed by baking the vulcanization adhesive on the surface of the primer layer formed on the metal sheet, and then placing an unvulcanized rubber compound on the surface of the baked vulcanization adhesive, followed by heating under pressure at about 130° to about 210° C. for about 1 to about 60 minutes, or by applying a simple adhesive to the surface of the primer layer formed on the metal sheet, and bonding vulcanized rubber thereto, followed by heating under pressure generally at about 100° to about 210° C., though depending on the species of vulcanized rubber.

### EXAMPLES

The present invention will be described below, referring to Examples.

### Example 1

To the surface of a defatted, gold-plated stainless steel sheet a primer having the following composition was applied to a thickness of 1.5 μm, followed by drying at room temperature and baking at 220° C. for 30 minutes:

| | Parts by weight |
|---|---|
| Polyparavinylphenol (Maruka Linker M, a product | 36 |
| of Maruzen Petrochemical Co., Ltd.) | |
| Aluminum alkylacetoacetate diisopropylate | 63 |
| 2-Ethoxyethanol | 901 |

To the surface of the primer a commercially available phenol/epoxy resin-based vulcanization adhesive for fluororubber was applied to a thickness of 10 μm, followed by drying at room temperature and baking at 200° C. for 15 minutes:

| | Parts by weight |
|---|---|
| Sixon 300, a product of Rhom and Haas Co. | 64 |
| Sixon 311, a product of Rhom and Haas Co. | 64 |
| Methyl ethyl ketone | 872 |

Onto the surface of the vulcanization adhesive an unvulcanized fluororubber compound having the following composition was further placed, followed by press vulcanization at 180° C. for 6 minutes and then secondary vulcanization at 200° C. for 24 hours to prepare bonding test pieces:

| | Parts by weight |
|---|---|
| Fluororubber (Viton E45, a product of DuPont) | 100 |
| MT carbon black | 20 |
| Magnesium oxide (Magnesia #150, a product of | 6 |
| Kyowa Chemical Co., Ltd.) | |
| Calcium hydroxide | 3 |
| Vulcanizing agent (Curative #30, a product of DuPont) | 2 |
| Vulcanization promoter (Curative #20, a product of | 1 |
| DuPont) | |

Vulcanized rubber region on the bonding test piece was formed in a belt shape on the gold-plated stainless steel sheet and had a 1 mm-high projection of semi-circular cross-section formed at the center of the belt having a thickness of 0.2 mm and a total width of 2 mm.

The bonding test pieces were subjected to determination of percent residual rubber area, according to 90° Peeling Test Procedure (JIS K6256), and visual inspection of peeling states at the interfaces, at the initial stage and after dipping in hot water at 90° C. (measured not only in a non-compressed state, but also in a 50% compression-set state in the thickness direction of the product rubber region), or in 0.5% sulfuric acid at 90° C., each for 250 hours, 500 hours, and 1,000 hours. Evaluation of the peeling states at the interfaces was made and given by R for rubber rupture, RC for peeling at the interface between the rubber and the adhesive, CP for peeling at the interface between the adhesive and the primer, and M for peeling at the interface between the metal and the primer.

### Example 2

In Example 1, the same amount of titanium lactate was used in place of aluminum alkylacetoacetate diisopropylate of the primer ingredient.

### Comparative Example 1

In Example 1, a primer having the following composition was used in place of the primer used in Example 1:

| | Parts by weight |
|---|---|
| Resol-type phenol resin (Resitop PL-2208, a product | 40 |
| of Gun-ei Chemical Co., Ltd.; solid matter | |
| concentration: 63 wt. %) | |
| Ethylacetoacetate aluminum diisopropylate | 25 |
| 2-Ethoxyethanol | 935 |

### Comparative Example 2

In Example 1, a silane coupling agent-based surface treatment agent (AP-133, a product of Rhode Far East Co.) was used as the primer, and the baking treatment was carried out at 200° C. for 15 minutes.

### Comparative Example 3

In Example 1, a primer for vulcanization bonding, which comprised alkoxysilane copolymerization oligomer, titanium tetra(acetylacetonate), methanol, and water, as disclosed in Example 1 of the afore-mentioned Patent Literature 1, was used as the primer, and the baking treatment was carried out at 200° C. for 15 minutes.

Results of determination and evaluation obtained in the foregoing Examples 1 and 2, and Comparative Examples 1 to 3 are shown in the following Table 1.

TABLE 1

| | Example No. | | Comp. Ex. No. | | |
|---|---|---|---|---|---|
| Conditions for determination | 1 | 2 | 1 | 2 | 3 |

Initial stage

| | | | | | |
|---|---|---|---|---|---|
| Percent residual rubber area (%) | 100 | 100 | 100 | 100 | 100 |
| Peeling at the interface | R | R | R | R | R |

After dipping in hot water at 90° C. for 250 hours

| | | | | | |
|---|---|---|---|---|---|
| (without compression) | | | | | |
| Percent residual rubber area (%) | 100 | 100 | 100 | 20 | 100 |
| Peeling at the interface | R | R | R | M | R |
| (50% compression) | | | | | |
| Percent residual rubber area (%) | 100 | 100 | 100 | 10 | 100 |
| Peeling at the interface | R | R | R | M | R |

After dipping in hot water at 90° C. for 500 hours

| | | | | | |
|---|---|---|---|---|---|
| (without compression) | | | | | |
| Percent residual rubber area (%) | 100 | 100 | 80 | 0 | 100 |
| Peeling at the interface | R | R | CP | M | R |
| (50% compression) | | | | | |
| Percent residual rubber area (%) | 90 | 100 | 70 | 0 | 100 |
| Peeling at the interface | CP | R | CP | M | R |

After dipping in hot water at 90° C. for 1,000 hours

| | | | | | |
|---|---|---|---|---|---|
| (without compression) | | | | | |
| Percent residual rubber area (%) | 80 | 100 | 50 | — | 100 |
| Peeling at the interface | CP | R | CP | — | R |
| (50% compression) | | | | | |
| Percent residual rubber area (%) | 80 | 90 | 40 | — | 90 |
| Peeling at the interface | CP | CP | CP | — | R |

After dipping in sulfuric acid at 90° C. for 250 hours

| | | | | | |
|---|---|---|---|---|---|
| Percent residual rubber area (%) | 100 | 100 | 100 | 0 | 20 |
| Peeling at the interface | R | R | R | M | M |

After dipping in sulfuric acid at 90° C. for 500 hours

| | | | | | |
|---|---|---|---|---|---|
| Percent residual rubber area (%) | 90 | 100 | 60 | — | 0 |
| Peeling at the interface | M | R | CP | — | M |

After dipping in sulfuric acid at 90° C. for 1,000 hours

| | | | | | |
|---|---|---|---|---|---|
| Percent residual rubber area (%) | 80 | 90 | 30 | — | — |
| Peeling at the interface | CP | CP | CP | — | — |

### Examples 3 and 4, and Comparative Examples 4 to 6

In Examples 1 and 2, and Comparative Examples 1 to 3, the following adhesive was used in the place of the vulcanization adhesive:

| | Parts by weight |
|---|---|
| Epoxy resin (EP-4100, a product of Asahi Denka | 926 |
| Kogyo K.K.) | |
| Dicyandiamide (EH-3636AS, a product of Asahi | 8 |
| Denka Kogyo K.K.) | |

Bonding with the adhesive was carried out by applying the adhesive to a primer-coated, gold-plated stainless steel sheet to a thickness of 10 μm, placing thereon a vulcanized rubber (1.5 mm-thick sheet obtained by press vulcanizing the unvulcanized fluororubber compound used in Example 1 at 180° C. for 6 minutes, followed by secondary vulcanization at 200° C. for 24 hours), and curing the adhesive under pressure at 150° C. for one hour.

Results of determination and evaluation obtained in the foregoing Examples 3 and 4, and Comparative Examples 4 to 6 are shown in the following Table 2.

TABLE 2

| | Example No. | | Comp. Ex. No. | | |
|---|---|---|---|---|---|
| Conditions for determination | 3 | 4 | 4 | 5 | 6 |

Initial stage

| | | | | | |
|---|---|---|---|---|---|
| Percent residual rubber area (%) | 100 | 100 | 100 | 100 | 100 |
| Peeling at the interface | R | R | R | R | R |

After dipping in hot water at 90° C. for 250 hours

| | | | | | |
|---|---|---|---|---|---|
| (without compression) | | | | | |
| Percent residual rubber area (%) | 100 | 100 | 100 | 20 | 100 |
| Peeling at the interface | R | R | R | M | R |
| (50% compression) | | | | | |
| Percent residual rubber area (%) | 100 | 100 | 100 | 0 | 100 |
| Peeling at the interface | R | R | R | M | R |

After dipping in hot water at 90° C. for 500 hours

| | | | | | |
|---|---|---|---|---|---|
| (without compression) | | | | | |
| Percent residual rubber area (%) | 100 | 100 | 100 | 0 | 100 |
| Peeling at the interface | R | R | R | M | R |
| (50% compression) | | | | | |
| Percent residual rubber area (%) | 80 | 100 | 70 | — | 90 |
| Peeling at the interface | CP | R | RC | — | R |

After dipping in hot water at 90° C. for 1,000 hours

| | | | | | |
|---|---|---|---|---|---|
| (without compression) | | | | | |
| Percent residual rubber area (%) | 100 | 100 | 100 | — | 100 |
| Peeling at the interface | R | R | R | — | R |
| (50% compression) | | | | | |
| Percent residual rubber area (%) | 80 | 90 | 30 | — | 80 |
| Peeling at the interface | CP | R | R | — | R |

After dipping in sulfuric acid at 90° C. for 250 hours

| | | | | | |
|---|---|---|---|---|---|
| Percent residual rubber area (%) | 100 | 100 | 100 | 0 | 0 |
| Peeling at the interface | R | R | R | M | M |

After dipping in sulfuric acid at 90° C. for 500 hours

| | | | | | |
|---|---|---|---|---|---|
| Percent residual rubber area (%) | 100 | 100 | 70 | — | — |
| Peeling at the interface | M | R | CP | — | — |

After dipping in sulfuric acid at 90° C. for 1,000 hours

| | | | | | |
|---|---|---|---|---|---|
| Percent residual rubber area (%) | 80 | 100 | 30 | — | — |
| Peeling at the interface | CP | CP | CP | — | — |

### Examples 5 and 6, and Comparative Examples 7 to 9

In Examples 1 and 2, and Comparative Examples 1 to 3, the a vulcanization adhesive having the following composition was used:

| | Parts by weight |
|---|---|
| Adhesive for liquid fluororubber (SF-12, a product of | 100 |
| Shin-Etsu Chemical Co., Ltd.) | |
| Hexafluoro-m-xylene | 100 |

The adhesive was applied to a primer-coated, gold-plated stainless steel sheet to a thickness of 2 μm, dried at room temperature, and baked at 120° C. for 10 minutes to form a primer- and vulcanization adhesive-coated, gold-plated stainless steel sheet. A liquid fluororubber (SIFEL 3511A/B, a product of Shin-Etsu Chemical Co., Ltd.) was injection molded onto the stainless steel sheet by a liquid rubber injection molding machine, and then subjected to secondary vulcanization at 200° C. for 4 hours to obtain an adhesion test pieces for gasket (stainless steel/primer/adhesive/fluororubber laminates).

Results of determination and evaluation obtained in the foregoing Examples 5 and 6, and Comparative Examples 7 to 9 are shown in the following Table 3. Hot water test was carried out only under the 50% compression-set conditions.

TABLE 3

| | Example No. | | Comp. Ex. No. | | |
|---|---|---|---|---|---|
| Conditions for determination | 5 | 6 | 7 | 8 | 9 |

Initial stage

| | | | | | |
|---|---|---|---|---|---|
| Percent residual rubber area (%) | 100 | 100 | 100 | 100 | 100 |
| Peeling at the interface | R | R | R | R | R |

After dipping in hot water at 90° C. for 250 hours

| | | | | | |
|---|---|---|---|---|---|
| (50% compression) | | | | | |
| Percent residual rubber area (%) | 100 | 100 | 100 | 30 | 100 |
| Peeling at the interface | R | R | R | M | R |

After dipping in hot water at 90° C. for 500 hours

| | | | | | |
|---|---|---|---|---|---|
| (50% compression) | | | | | |
| Percent residual rubber area (%) | 90 | 100 | 70 | 0 | 100 |
| Peeling at the interface | CP | R | CP | M | R |

After dipping in hot water at 90° C. for 1,000 hours

| | | | | | |
|---|---|---|---|---|---|
| (50% compression) | | | | | |
| Percent residual rubber area (%) | 90 | 100 | 60 | — | 90 |
| Peeling at the interface | CP | R | CP | — | R |

After dipping in sulfuric acid at 90° C. for 250 hours

| | | | | | |
|---|---|---|---|---|---|
| Percent residual rubber area (%) | 100 | 100 | 100 | 0 | 60 |
| Peeling at the interface | R | R | R | M | M |

After dipping in sulfuric acid at 90° C. for 500 hours

| | | | | | |
|---|---|---|---|---|---|
| Percent residual rubber area (%) | 90 | 100 | 60 | — | 20 |
| Peeling at the interface | M | R | CP | — | M |

After dipping in sulfuric acid at 90° C. for 1,000 hours

| | | | | | |
|---|---|---|---|---|---|
| Percent residual rubber area (%) | 90 | 100 | 30 | — | 0 |
| Peeling at the interface | CP | R | CP | — | M |

### INDUSTRIAL UTILITY

The present primer composition can be effectively used in the production of rubber-metal integrated type gaskets, particularly fuel cell gaskets or HDD cover gaskets (metallic separator-integrated type gaskets).

1. A primer composition for use as a primer in the production of metal/primer/adhesive/rubber laminates, which comprises 100 parts by weight of polyparavinylphenol and 50-300 parts by weight of an organometallic compound.

2. A primer composition according to claim 1, wherein the organometallic compound is a compound having at least one chelate ring and/or alkoxyl group.

3. A primer composition according to claim 2, wherein the organometallic compound is an organoaluminum compound.

4. A primer composition according to claim 3, wherein the organoaluminum compound is a compound, represented by the following formula: 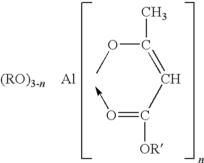
where R and R′ each are a lower alkyl group having 1-4 carbon atoms, and n is an integer of 0-3.

5. A primer composition according to claim 2, wherein the organometallic compound is an organotitanium compound.

6. A primer composition according to claim 5, wherein the organotitanium compound is titanium actylacetonate, represented by the following formula:

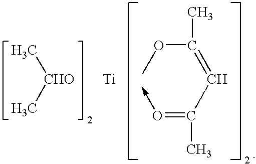

7. A primer composition according to claim 5, wherein the organotitanium compound is titanium lactate, represented by the formula:
Ti(OH)₂[OCH(CH₃)COOH]₂.

8. A metal/primer/adhesive/rubber laminate produced by using a primer composition according to claim 1.

9. A metal/primer/adhesive/rubber laminate according to claim 8, wherein the primer composition is used as a primer in vulcanization bonding of a steel sheet and unvulcanized rubber.

10. A metal/primer/adhesive/rubber laminate according to claim 9, wherein the unvalcanized rubber is unvulcanized fluororubber.

11. A metal/primer/adhesive/rubber laminate according to claim 10, wherein the unvalcanized fluororubber is unvalcanized liquid fluororubber.

12. A metal/primer/adhesive/rubber laminate according to claim 8, wherein the primer composition is used as a primer in bonding of a steel sheet and vulcanized rubber.

13. A metal/primer/adhesive/rubber laminate according to claim 9, wherein the steel sheet is a plated steel sheet.

14. A metal/primer/adhesive/rubber laminate according to claim 12, wherein the steel sheet is a plated steel sheet.

15. A metal/primer/adhesive/rubber laminate according to claim 8, for use as a rubber-metal integrated type gasket.

16. A rubber-metal integrated type gasket according to claim 15, for use as a fuel cell gasket or as a HDD cover gasket.
